(19) United States
(12) Patent Application Publication
(10) Pub. No.: US 2021/0174012 A1
(43) Pub. Date: Jun. 10, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Yuji KAZAMA, Kanagawa (JP)

(73) Assignee: FUJI XEROX CO., LTD., Tokyo (JP)

(21) Appl. No.: 16/849,983

(22) Filed: Apr. 15, 2020

(30) Foreign Application Priority Data
Dec. 5, 2019 (JP) 2019-220553

(51) Int. Cl. G06F 40/197; G06F 40/166; G06F 21/62; G06F 16/93

(52) U.S. Cl. CPC G06F 40/197; G06F 16/93; G06F 21/6209; G06F 40/166

(57) ABSTRACT

An information processing apparatus includes a processor configured to, in a case where a first document element is changed, and a response of a participant of a second document element related to the first document element to a notification of requiring a check of necessity for changing the second document element to correspond to the first document element is not possible, transmit the notification to a participant of a third document element related to the first document element or the second document element.

### CROSS-REFERENCE TO RELATED APPLICATIONS

This application is based on and claims priority under 35 USC 119 from Japanese Patent Application No. 2019-220553 filed Dec. 5, 2019.

### BACKGROUND

### (i) Technical Field

The present invention relates to an information processing apparatus and a non-transitory computer readable medium storing a program.

### (ii) Related Art

The world is full of interrelated documents. In a case where one of the interrelated documents is changed, some of the remaining documents may be required to be changed accordingly. There is a mechanism in which, in a case where a certain document is changed, a participant (for example, author) of a document related to the changed document is informed of the change, and thereby being urged to perform a required countermeasure such as a change of a document.

JP2012-150647A discloses a document data processing apparatus that performs data processing related to document data shared by a plurality of users. The document data processing apparatus includes a determination unit and a notification unit. When an instruction to update document data is made by the current editor being a user who edits the document data, the determination unit determines a level of the update of which the instruction is made, based on level setting information indicating a form of each level of the update, which is classified into a plurality of levels in advance. The notification unit uses notification setting information in which necessity of a notification for each of the plurality of levels and a notification destination in a case where the notification is transmitted are defined, as a reference. In a case where the level determined by the determination unit is a level of which a notification is to be made, a user defined as the notification destination at the determined level is notified of change details including a change location of the document data in the update of which the instruction has been received.

### SUMMARY

There is a system that, in a case where a first document element is changed, notifies a participant of a second document element related to the first document element, to request a check of whether or not a change of the second document element is required in response to the change. In this type of system, in a case where there is no participant of the second document element, or the participant does not respond to the notification, the check of whether or not the change of the second document element is required in response to the change of the first document element, or the change of the second document element is not appropriately performed.

Aspects of non-limiting embodiments of the present disclosure relate to an information processing apparatus and a non-transitory computer readable medium storing a program, in which the chances for checking whether or not a change of a second document element related to a first document element is required in response to a change of a first document is increased, in comparison to a case where a notification of requesting the check of whether or not the change of the second document element is required in response to the change of the first document is transmitted to only a participant of the second document element.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to, in a case where a first document element is changed, and a response of a participant of a second document element related to the first document element to a notification of requiring a check of necessity for changing the second document element to correspond to the first document element is not possible, transmit the notification to a participant of a third document element related to the first document element or the second document element.

### BRIEF DESCRIPTION OF THE DRAWINGS

Exemplary embodiment(s) of the present invention will be described in detail based on the following figures, wherein:

FIG. 1 is a diagram illustrating a configuration of an entire system including a document service system;

FIG. 2 is a diagram illustrating an example of a document creation operation in the system in FIG. 1;

FIG. 3 is a diagram illustrating a hardware configuration of a computer on which the document service system is mounted;

FIG. 4 is a diagram illustrating an example of a database construction and maintenance processing procedure performed by the document service system;

FIG. 5 is a diagram illustrating a structure of a document;

FIG. 6 is a diagram illustrating a data structure of a document property in a database;

FIG. 7 is a diagram illustrating a data structure of an element property in the database;

FIG. 8 is a diagram illustrating relation information in the database;

FIG. 9 is a diagram illustrating another example of the data structure of the database;

FIG. 10 is a diagram illustrating an order of selecting a transmission destination of a change notification regarding a notification target element;

FIG. 11 is a diagram illustrating a procedure of processing performed by the document service system when a change of a document element is detected;

FIG. 12 is a diagram illustrating an internal procedure of change notification processing in the procedure in FIG. 11;

FIG. 13 is a diagram illustrating a procedure of the notification processing performed in each step of the procedure of FIG. 12;

FIG. 14 is a diagram illustrating an example of a change notification screen;

FIG. 15 is a diagram illustrating an order of selecting the transmission destination of the change notification in a case where a participant of a document element included in a document separate from the notification target element is also set to a candidate for the transmission destination;

FIG. 16 is a diagram illustrating an internal procedure of the change notification processing in a case where the participant of the document element included in the document separate from the notification target element is also set to the candidate for the transmission destination; and

FIG. 17 is a diagram illustrating a procedure of enabling a participant as the transmission destination of the change notification to edit the notification target element.

### DETAILED DESCRIPTION

Example of Entire System

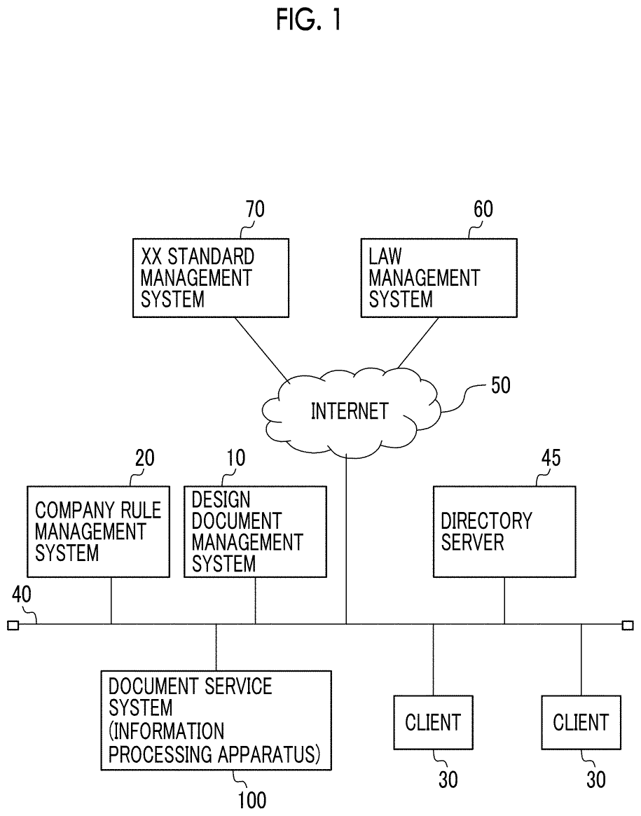

FIG. 1 illustrates an entire system for using a document, which includes a document service system 100 being an exemplary embodiment of an information processing apparatus according to an exemplary embodiment of the present invention.

In the example, a document service system 100 is connected to an internal network 40 in a certain company. One or more document management systems for managing various internal documents, such as a design document management system 10 or a company rule management system 20, are connected to the internal network 40. In addition, a directory server 45 that manages information on a user in the company is provided on the internal network 40. The information on the user, which is managed by the directory server 45 includes items of a user ID (that is, identification information), a belonging group, a role, and a contact address. In a case where a different user ID is used by the system (for example, design document management system 10 and directory server 45) on the internal network 40, the directory server 45 holds the user ID of the user for each system. Example of the information on a belonging group of the user includes an ID of a group such as a department or a project to which the user belongs. The information on the belonging group of the user may include the history of a group to which the user belonged in the past (that is, information of a belonging group for each period). The information on the contact address of the user includes a telephone number, an e-mail address, a user ID in a social network service, and the like. A client 30 such as a personal computer operated by a user is connected to the internal network 40.

Various document management systems such as a law management system 60 and an XX standard management system 70 that manages standard documents of an “XX” technology are provided on the Internet 50. Apparatuses such as the document service system 100 and a client 30 on the internal network 40 are capable of accessing documents of the document management system on the Internet 50.

In a case where one document related to another document in an internal document management system such as the design document management system 10 is changed, the document service system 100 provides a service (for example, notifying a concerned person of the change) corresponding to the change of the one document for the another document.

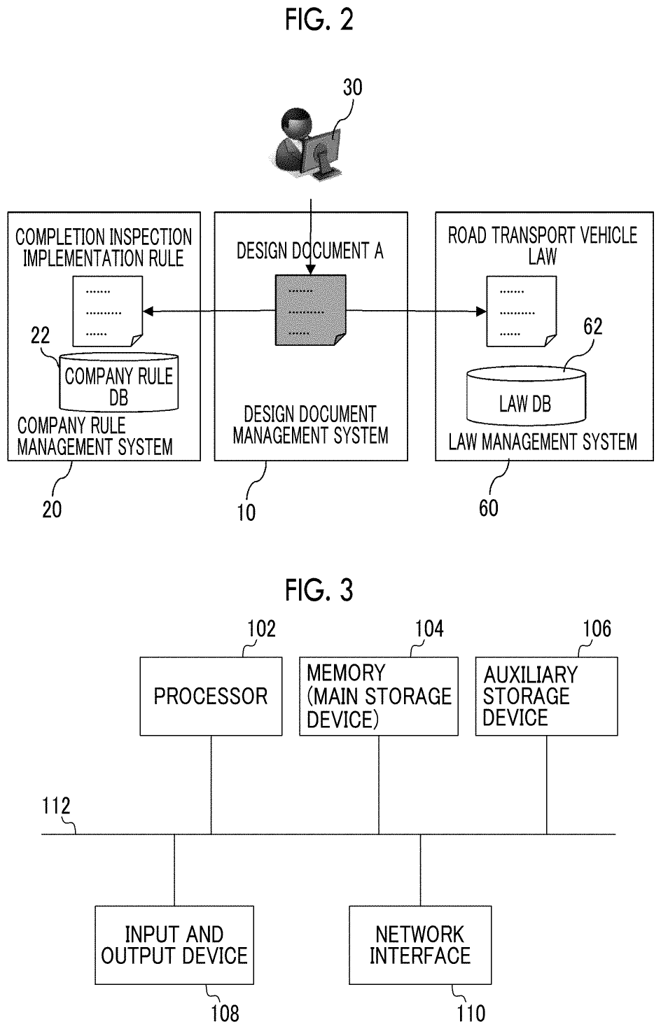

As illustrated in FIG. 2, a case where a user in a company creates a design document A of a product, registers the created document in the design document management system 10, and maintains the registered document is considered. Since the product is required to be designed to satisfy various laws and various company rules, the design document A is also created with reference to other documents such as the laws and the company rules. For example, the design document A is created with reference to the Road Transport Vehicle Law registered in a law DB 62 of the law management system 60 and a completion inspection implementation rule registered in a company rule DB 22 of the company rule management system 20. The law in the law DB 62 and the rule in the company rule DB 22 are updated at any time in accordance with the revision.

In a case where the Road Transport Vehicle Law and the completion inspection implementation rule are revised, the content of the design document A may be required to be updated, but the update is not always necessary. For example, in a case where the revised part of the law or the like is different from the part on which the content of the design document A depends, the content of the design document A is not required to be updated.

In addition, even though the design document A is created based on a certain part of the law, various methods of depending on the part are provided. For example, there is a case where a section of the law is cited in the design document A by copying the section itself, and there is a case where coincidence of terms between the relevant part of the law and a part of the design document A can be found just by describing the part of the design document A while checking the relevant part of the law. In the former case, necessity to correct the cited part in the design document A by the section of the law being revised is high. On the contrary, in the latter case, the degree of necessity for a response of the design document A to the revision of the relevant part of the law is lower than the degree of necessity in the former case.

Thus, in the exemplary embodiment, the document service system 100 provides a participant of a document, such as a person in charge of managing the design document A, with, for example, a service of supporting an operation of determining whether or not the document is required to be changed in response to a change of another document related to the above document.

Here, the “document” refers to data in any data format, and the data format is not particularly limited. For example, the document may refer to data in a text data format or in various document file formats such as a PDF format. The document may refer to image data in various image data formats or a moving image data. The document may refer to data in a structured document format such as a Hypertext Markup Language (HTML) format or an Extensible Markup Language (XML) format.

In this specification, “a participant” for a document refers to an individual or a user group involved in maintaining the content of the document. The participant may be, for example, a person in charge of maintenance of the content of the document, or may have a role of urging the person in charge to perform the maintenance. For example, a user who has created the document or a user who has updated the document is a representative example of the participant. A document may be configured with a plurality of document elements, and a participant may be set for each document element.

Example of Hardware Configuration

The document service system 100 is implemented by causing a computer to execute a program representing a function of the system.

Here, for example, as illustrated in FIG. 3, a computer serving as a base of the document service system 100 has a circuit configuration as follows, as hardware. In the circuit configuration, a processor 102, a memory (main storage device) 104 such as a random access memory (RAM), a controller for controlling an auxiliary storage device 106 such as a flash memory, a solid state drive (SSD), and a hard disk drive (HDD), an interface with various input and output devices 108, and a network interface 110 for controlling a connection with a network such as a local area network are connected to each other via a data transmission path such as a bus 112, for example. A program in which the processing content of each function of the document service system 100 is described is installed on the computer via the network or the like, and is stored in the auxiliary storage device 106. Functions of the document service system 100 are realized by the processor 102 executing the program stored in the auxiliary storage device 106 using the memory 104.

In the embodiments above, the term “processor” 102 refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” 102 is broad enough to encompass one processor 102 or plural processors 102 in collaboration which are located physically apart from each other but may work cooperatively. The order of operations of the processor 102 is not limited to one described in the embodiments above, and may be changed.

Other apparatuses such as the design document management system 10, the company rule management system 20, and the client 30 are also configured using a computer as a base, similar to the document service system 100.

Database Construction

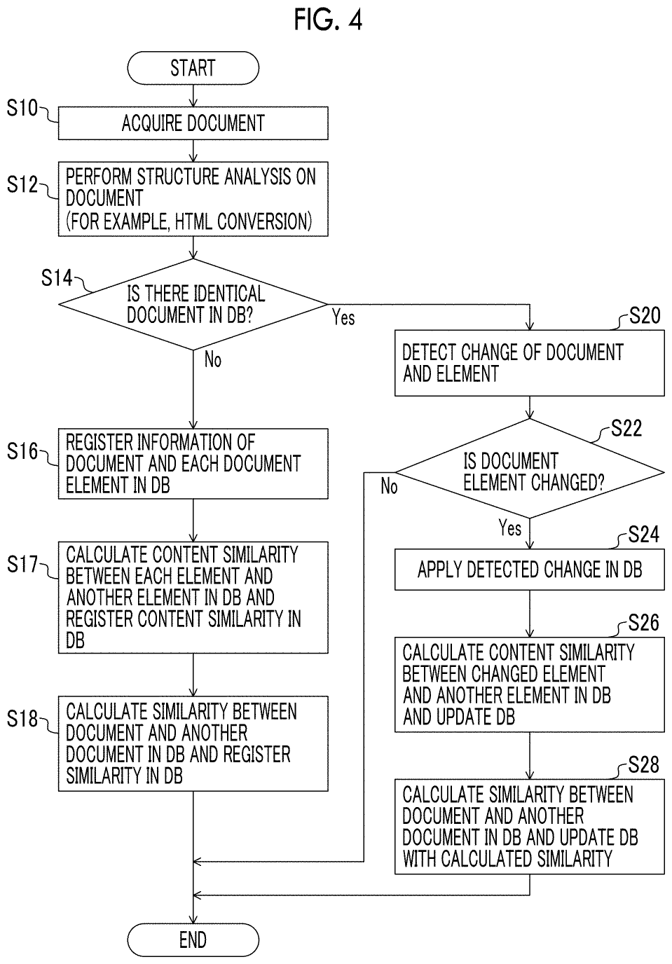

An example of database construction processing used for the document service system 100 providing a service will be described with reference to FIGS. 4 to 8. The database is constructed in the auxiliary storage device 106 in the document service system 100.

For example, the document service system 100 periodically visits predetermined document management systems inside and outside a company, such as the design document management system 10, the company rule management system 20, and the law management system 60, so as to acquire and analyze a document group registered in the document management systems. In this case, the document service system 100 analyzes information of which a notification is made. A procedure illustrated in FIG. 4 shows a process performed when the document service system 100 acquires one document from any document management system (S10).

In this case, the processor 102 in the document service system 100 analyzes the structure of the acquired document to divide the document into document element units (S12). The structure analysis is performed, for example, by processing of converting a document into a HyperText Markup Language (HTML) format. Various tools for HTML conversion are provided. In S12, a tool appropriate for the file format of the document may be used. Alternatively, the structure analysis may be performed using a known technology of recognizing the structure of a heading, a chapter, a section, a paragraph, or the like from the document content. In a case where the acquired document is already a structured document in the XML format or the like, the process of S12 may be omitted.

Then, the processor 102 determines whether or not data of a document identical to the document acquired in S10 is registered in a database (S14). Here, “identical” does not mean that the entire contents of the documents are identical to each other, but that the documents have the identical identification information. The identification information of a document is referred to as a document ID. In S14, whether or not information on a document having a document ID identical to a document ID of the acquired document is in the database is determined.

As the document ID, for example, a combination of identification information of the document management system (for example, company rule management system 20 or law management system 60) as an acquisition source of the document and identification information of the document in the document management system may be used. For example, a uniform resource locator (URL) of the document in the document management system may be used as the document ID of the document.

In a case where the determination result in S14 is No, the document acquired in S10 is a document that the processor 102 firstly encounters. In this case, the processor 102 registers information on the document acquired in S10 and information on each document element obtained by the structure analysis in S12, in the database (S16).

The processor 102 calculates the similarity of the content of each document element with contents of other document elements registered in the database, and registers the obtained similarity in the database for each document element (S17). The similarity of the content between the document elements may be obtained, for example, in a manner that a text string included in the document element is vectorized, and similarity between the obtained vectors of the document elements is calculated by a known method (for example, cosine similarity). As a method of vectorizing the text string of the document element, a known method such as term frequency-inverse document frequency (TF-IDF) or doc2vec may be used.

Here, “the other document element” being a partner for obtaining the similarity with the document element obtained in S12 is typically a document element of another document registered in the database. However, the present invention is not limited to the above method, and the similarity between the document elements obtained in S12 may be further calculated.

The processor 102 calculates the similarity between the document acquired in S10 and another document registered in the database, and registers the similarity of the calculation result in the database (S18). For example, text strings obtained in a manner that text strings of headings of a chapter and a section in the document obtained by the structure analysis in S12 are arranged and merged in order of appearing are set as text strings indicating characteristics of the document, and the text strings are vectorized. The similarity between the vectors of the text strings indicating the characteristics of the documents obtained in this manner is obtained as the similarity between the documents. A method of calculating the similarity between documents is not limited to this. In addition, for example, a tree structure configured with document elements (for example, chapters, sections, and paragraphs) in a document may be set as characteristics of the document, and the similarity between the characteristics may be set as the similarity between documents.

In a case where the determination result in S14 is Yes, data of the document acquired in S10 is registered in the database of the document service system 100. In this case, the processor 102 examines whether or not the document acquired in S10 and each document element obtained in S12 have been changed from the document and document element registered in the database (S20). In this step, for example, for each document element obtained in S12, the processor compares the content of the document element (that is, text string) with the content of the identical document element (that is, document element having the identical identification information) in the database. In a case where both the contents coincide with each other, the processor determines that the document elements are not changed. In a case where both the contents do not coincide with each other, the processor determines that the document elements are changed. A case where the document element identical to the document element obtained in S12 is not in the database or a case where a document element identical to a document element in the database is not provided in the structure analysis result in S12 corresponds to an example of a case where the document element is changed. A case where any one or more document elements are determined to be changed refers to a case where the entire document is changed. A case where there is no document element determined to be changed refers to a case where the entire document is not changed.

The processor 102 determines whether or not the change in the document or the document element has been detected in S20 (S22). In a case where the change has been detected, the processor 102 applies information on the detected change in the database (S24). For example, in a case where the content of a certain document element has been changed, the content of the document element in the database is updated to the content after the change. For a document element of which no change has been detected, the information registered in the database is not required to be changed. In a case where the change of the document element in the document is detected, information such as the update date and time of the document in the database is changed.

The processor 102 calculates the similarity of the content between the document element of which the change of the content has been detected in S20, and another document element in the database. The processor updates the value of the similarity between the document elements, which has been registered in the database, to a value obtained by the calculation (S26). In a case where the document element of which the change of the content has been detected in S20 is a new document element which is not in the database, the processor calculates the similarity between the new document element and another document element in the database, and registers the similarity in the database. In a case where deletion of the document element which has been in the database is detected in S20, information on the similarity between the deleted document element and another document element may be deleted from the database. The process of S26 is not performed on the document element of which the change has not been detected.

The processor 102 calculates the similarity between the document acquired in S10 and another document in the database in a manner similar to that in S18. Then, the processor updates the similarity between this document and another document in the database, in accordance with the calculation result (S28).

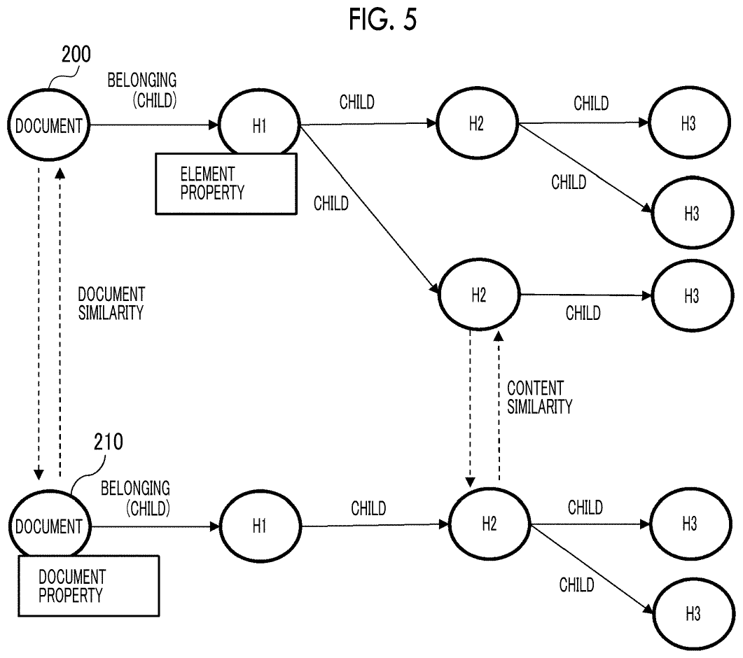

An example of information registered in the database in the document service system 100 will be described with reference to FIGS. 5 to 8.

FIG. 5 illustrates information on a structure analysis result of two documents 200 and 210 registered in the database by HTML. The document 200 has an H1 element (for example, title of the document) as a child document element (referred to as a child element below), and the H1 element has two H2 elements as child elements. The H2 elements have two H3 elements and one H3 element, as a child element, respectively. As described above, structure information on the document 200 is represented by a tree structure illustrated in FIG. 5. Unique identification information is assigned to the document and each document element. Data representing the tree structure illustrated in FIG. 5 is registered, as the structure information on the document, in the database in association with the identification information of the document.

Property data (referred to as “document property”) for each of the documents 200 and 210 and property data (referred to as “element property”) for each document element are registered in the database.

The similarity between the document 200 and the document 210 is calculated and registered in the database. The similarity of the content between the document elements is calculated and registered in the database.

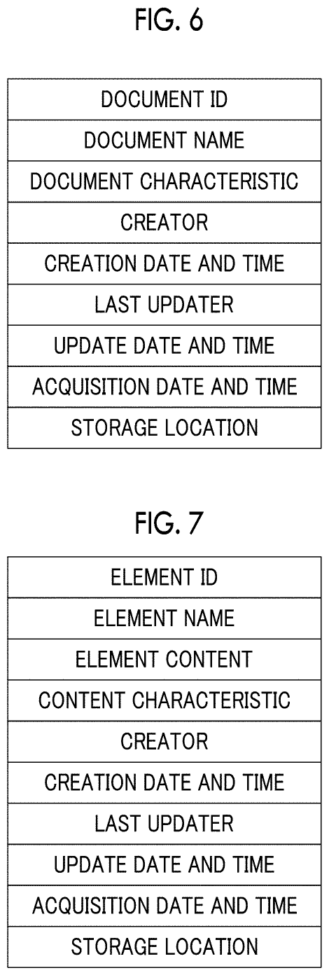

FIG. 6 illustrates an example of a data structure of the document property registered in the database. The document property of the document illustrated in FIG. 6 includes items such as a document ID, a document name, a document characteristic, a creator, the creation date and time, the last updater, the update date and time, the acquisition date and time, and a storage location of the document. The document name is, for example, a filename of the document. The document characteristic refers to data indicating the characteristics of the document. For example, as described above, a text string obtained by arranging and merging text strings of headings of a chapter and a section in the document in order of appearing is provided as an example of the document characteristic. The resultant obtained by vectorizing the text string may be used as the document characteristic. The creator indicates the user ID of a user who has firstly created the document, and the creation date and time indicate the date and time of creation. The last updater indicates the user ID of a user who has updated the document last, and the update date and time indicate the date and time of the update. The types of information on the creator, the creation date and time, the last updater, and the update date and time may be acquired from attribute data of the file of the document, for example. The acquisition date and time indicate the date and time on which the processor 102 has acquired the document last from the document management system such as the company rule management system 20 or the law management system 60. The storage location refers to information of specifying the document management system in which the document has been originally stored (for example, URL of the document management system).

In S18 and S26 in the procedure of FIG. 4 described above, such information on the document property and information on the tree structure of the document obtained in S12 are registered in the database.

FIG. 7 illustrates an example of a data structure of the element property registered in the database. The element property of the document element illustrated in FIG. 7 include items such as an element ID, an element name, an element content, a content characteristic, a creator, the creation date and time, the last updater, the update date and time, the acquisition date and time, and a storage location of the document element. The element ID refers to identification information of the document element. For example, a set of a document ID of a document including the document element and a number uniquely assigned to the document element in the document may be used as the element ID. The element name refers to the name of the document element. For example, in a case where the document element includes a heading, the heading may be used as the element name. In a case where the document element does not include the heading, a text string having a predetermined number of characters at the head of the document element may be used as the element name. The element content refers to data of the content of the document element. For example, in a case where the document element is a text, the element content is a text string of the text. The element characteristic refers to data indicating the characteristic of the document element, and is obtained by vectorizing the text string of the document element described above, for example. The creator indicates the user ID of a user who has firstly created the document element, and the creation date and time indicate the date and time of creation. In a case where the original document file (or the document management system that manages the original document file) has information on the creator or the creation date and time for each document element, the information is registered in the item of the creator or the creation date and time in the element property. In a normal case where the file of the original document has only the creator and the creation date and time in a document unit, the creator and the creation date and time of the document are registered in the creator and the creation date and time of the document element included in the document in the element property.

The last updater indicates the user ID of a user who has updated the document element last, and the update date and time indicate the date and time of the update. In a case where the original document file (or the document management system that manages the original document file) has information on the last updater or the update date and time for each document element, the information is registered in the item of the last updater or the update date and time in the element property. In a normal case where the file of the original document has only the last updater and the update date and time in a document unit, values of the last updater and the update date and time of the document when the change of the content of the document element is detected are registered in the items of the last updater and the update date and time of the document element included in the document in the element property. Whether or not the content of the document element has been changed is determined by comparing the element content or the content characteristic of the document element obtained in S12 with the element content or the content characteristic of the document element in the database having the identical element ID.

The acquisition date and time refers to the date and time on which the processor 102 has acquired the document element last. The acquisition date and time is identical to the acquisition date and time of the document including the document element. The storage location refers to information of specifying the document management system in which the document element has been originally stored, and is identical to the storage location of a document including the document element.

In S16 of the procedure of FIG. 4 described above, information on each item of such element property is registered in the database. In S24, the processor updates the value of each item of the element property of the document element of which the change has been detected, to a value corresponding to the content of the change.

In a case where the document is acquired from an external document management system (for example, document management system outside the internal network 40), acquiring information on all items of the document property and the element property illustrated in FIGS. 6 and 7 for the above document may not be possible. Such an item is set to a null value, or a value obtained by the document service system 100 based on another type of information is set. For example, for a document acquired from the law management system 60, difficulty in obtaining information on the creator, the creation date and time, the last updater, and the update date and time from the document or the law management system 60 is considered. In this case, the items of the creator, the creation date and time, and the last updater may be set to null values. In a case where the change of the document element in the acquired document has been detected in S20 of the procedure in FIG. 4, the document service system 100 may set the date and time of the acquisition to the update date and time of the document element and the document.

The item group of the document property and the element property illustrated in FIGS. 6 and 7 are only examples. The document property and the element property are not required to include all of the illustrated items, and may include items that are not illustrated.

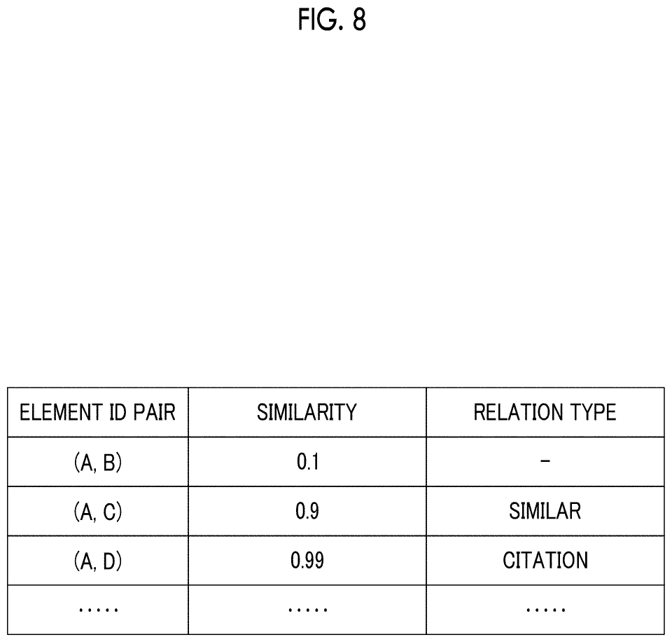

FIG. 8 illustrates relation information between document elements registered in the database. The relation information illustrated in FIG. 8 is associated with a pair of element IDs of two document elements. The relation information includes a value of the similarity of the content between the two document elements and the type of relation between the document elements, which is determined from the value. In the example, the types of relation between document elements are classified into several types in accordance with the magnitude of the similarity of the content between the document elements. For example, in a case where the similarity of the content between the document elements is equal to or greater than 0.95 (that is, 95%), the type of relation between the document elements is named “citation”. The type of relation in a case where the similarity of the content between the document elements is equal to or greater than 0.80 and smaller than 0.95 is named “similar”. In a case where the similarity is equal to or greater than 0.60 and smaller than 0.80, the type of relation is named “reference”. Ina case where the similarity is smaller than 0.60, the two document elements are determined to be unrelated.

Although not illustrated in FIG. 8, the date and time on which the similarity or the type of relation is determined may be further registered in the relation information.

In S17 and S26 in the procedure of FIG. 4, the similarity between the document elements and the type of the relation corresponding to the similarity are determined, and the values are registered in the relation information illustrated in FIG. 8.

The relation information illustrated in FIG. 8 is merely an example. As the relation information, information that includes similarity but does not include the type of relation may be used, and conversely, information that does not include similarity but includes the type of relation may be used.

In the example described with reference to FIGS. 4 to 8, the type of the relation between the document elements is determined in accordance with the similarity of the content between the document elements, but this is just an example.

For example, a user who has created or updated a document element may register another document element having a relation with the document element and the type of the relation in the document service system 100.

A device that provides a user with a function of editing a document (for example, a document editing application provided by the client 30) may determine a relation between document elements in accordance with an operation performed by the user while the user is editing a document element, and the device may register the determined relation in the document service system 100. For example, in a case where the user copies a document element a in a document A opened on a screen of the device to a document element b in another document B opened on the screen by a copy and paste operation, the device determines that the document element b has the type of relation of “citation” to the document element a. Then, the device registers the relation of “citation” in the document service system 100. For example, in a case where another document element d is opened on the screen (copy and paste of the document elements d to c is not performed) while the user is editing a document element c opened on the screen, the device determines that the document element c has a relation of “reference” to the document element d.

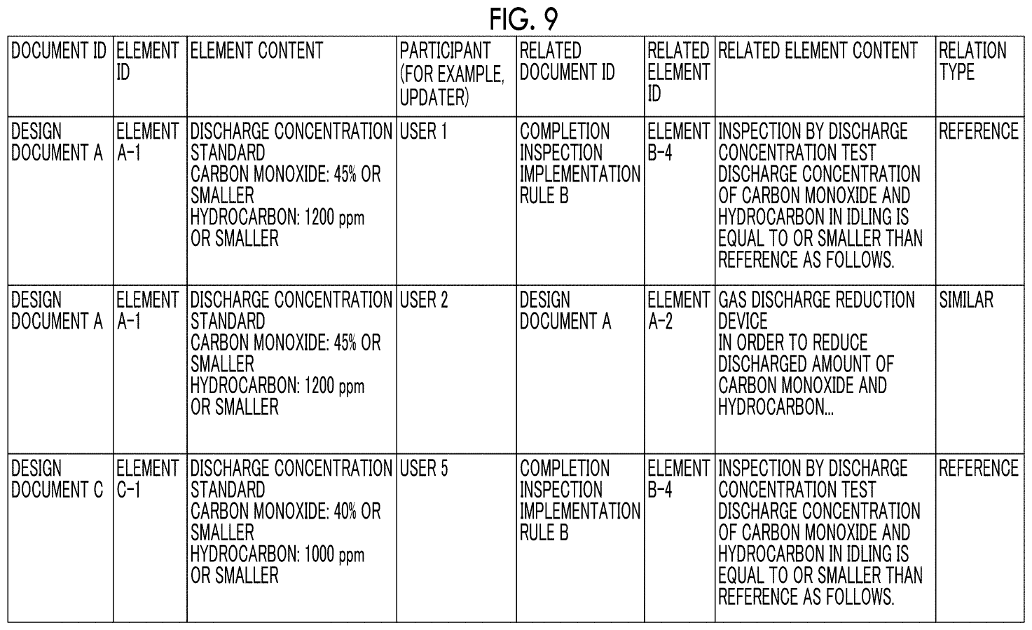

FIG. 9 illustrates a structure different from the structure illustrated in FIGS. 5 to 8, as the structure of the database in the document service system 100. The database structure illustrated in FIG. 9 has one record (that is, one row in a table illustrated in FIG. 9) for each document element. The record of a document element includes items of “document ID”, “element ID”, “element content”, “participant”, “related document ID”, “related element ID”, “related element content”, and “relation type”. “Document ID” indicates a document ID of a document to which the document element belongs. “Element ID” indicates an element ID of the document element. “Element content” indicates the element content of the document element. “Participant” indicates the user ID of a participant of the document element. The participant of the document element is the creator or the last updater of the document element, for example. “Related document ID” indicates a document ID of a document (referred to as “related element” below) to which another document element related to the document element belongs. “Related element ID” indicates the element ID of the related element. “Related element content” indicates the element content of the related element. “Relation type” indicates the type of relation between the document element and the related element.

Notification Processing of Change of Document Element

A notification of a change of a document element, which is performed by the document service system 100 with reference to the above-described database will be described below.

In a case where a certain document element is changed, correcting another document element having a relation to the changed document element, in response to the change, may be required. For example, in a case where the description of a part in a design document of a product is described in accordance with the provisions of the law on which the part is based, and the provision is changed, the description of the part may be required to be changed.

Therefore, in the document service system 100, a participant of the latter document element is notified that the former document element has been changed. Thus, the participant checks whether the latter is required to be changed in response to the change of the former. In a case where the latter is required to be changed, the latter is changed.

When the change of the former document element is found, the participant of the latter document element may have disappeared from the company using the internal network 40 due to reasons such as retirement. In such a case, notifying the participant is not possible. Even though the notification can be performed, since there is no participant, the required check or countermeasure is not performed. Thus, the notification becomes useless. A case in which, even though the participant is present in the company, the participant does not perform an immediate and appropriate countermeasure for the notification, as in a case where the participant is absent in the company due to a long vacation at that time, may occur.

Assuming such a situation, in a case where a response of a participant of a document element related to a changed document element, to a notification of the change, is not possible, the document service system 100 transmits the notification to another user determined to have high eligibility. In the following description, for the simple description, a changed document element is referred to as “a changed element”. A document element which has a relation to the changed element and is set to a notification target of the change is referred to as “a notification target element”. The notification that the changed element is changed is referred to as “a change notification”.

“A case where a response of a participant of the notification target element to the change notification is not possible” includes a case where the participant is not a user of the document service system 100 (and thus the internal network 40). A case where the participant has retired at a time of the notification is provided as an example. In this case, the document service system 100 may recognize that the participant is not a registered user by referring to the directory server 45, and may not transmit a change notification to the participant. In such a case, “the case where responding is not possible” within a concept of “the case where a response of the participant to the change notification is not possible” also includes a case where the participant does not check whether or not the notification target element is required to be changed within a predetermined period in response to the change notification. For example, a case where an immediate response of the participant to the notification is not possible due to a long vacation corresponds to one example.

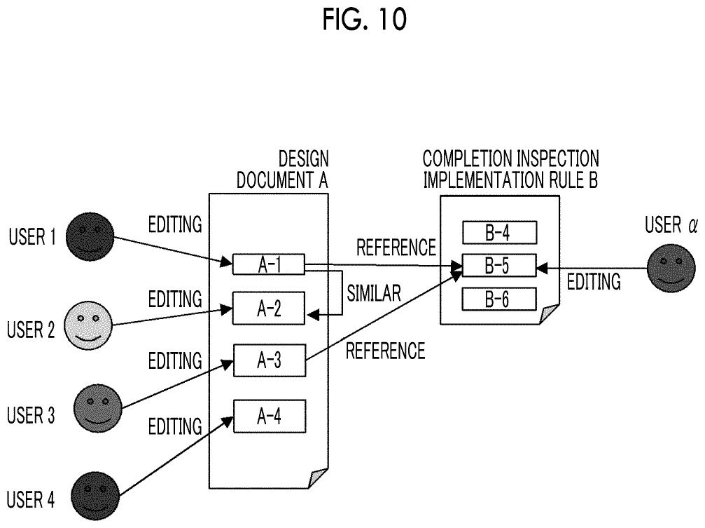

An example of a selection order of a transmission destination user to which the document service system 100 transmits the change notification will be described with reference to FIG. 10. The example of FIG. 10 illustrates an example in which a transmission destination user is selected from a participant group of a document element group in a document including the notification target element.

In the example of FIG. 10, “design document A” registered in the design document management system 10 is configured with document elements A-1, A-2, A-3, and A-4, and User 1, User 2, User 3, and User 4 are registered as participants (for example, last updaters). A document of “Completion inspection implementation rule B” registered in the company rule management system 20 includes document elements B-4, B-5, and B-6. The document elements A-1 and A-3 both have a relation of a “reference” type to the document element B-5. The document elements A-1 and A-2 have a “similar” relation to each other.

In this situation, a case where a user a edits the document element B-5 to change the content, and the document service system 100 selects the document element A-1 as the notification target element in response to the edit is considered. In this case, firstly, the document service system 100 attempts to transmit a change notification to the participant of the document element A-1 being the notification target element, that is, User 1.

In a case where a response of User 1 to the change notification is not possible, the document service system 100 attempts to transmit the change notification to a participant of the document element A-3 which similarly “refers to” the document element B-5, that is, User 3. The document element A-3 is in the identical document to the notification target element A-1, and refers to the identical changed document element B-5. Thus, a possibility that User 3 being the participant of the document element A-3 has knowledge of the notification target element A-1 is considered to be high. Thus, in a case where the response of User 1 is not possible, the notification attempts to be transmitted to User 3.

In a case where a response of User 3 to the change notification is not possible, the document service system 100 attempts to transmit the change notification to a participant of the document element A-2 having a relation of “similar” to the notification target element, that is, User 2. The document element A-2 is in the identical document to the notification target element A-1, and has the content similar to the content of the notification target element A-1. Thus, a possibility that User 2 being the participant of the document element A-2 has knowledge of the notification target element A-1 is considered to be high. Therefore, the notification attempts to be transmitted to User 2.

In a case where the response of neither User 3 nor User 2 to the change notification is possible, the document service system 100 attempts to transmit the change notification to a participant of the document element A-4 which is different from the notification target element in the identical document, that is, User 4. The document element A-4 has no relation to the changed document element B-5 and is not similar to the notification target element A-1. Since the document element A-4 is in the identical document to the notification target element A-1, User 4 being the participant of the document element A-4 may have knowledge of the notification target element A-1. Thus, in a case where the response of neither User 1, User 2 nor User 3 is possible, the notification attempts to be transmitted to User 4.

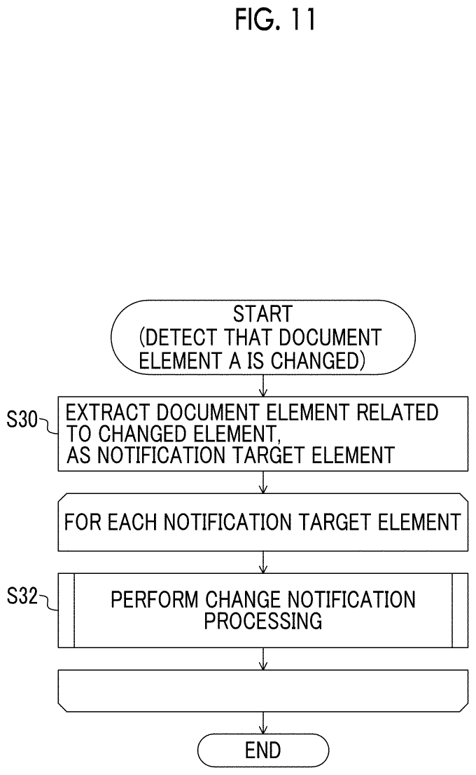

An example of the procedure of processing for the change notification described with reference to FIG. 10 will be described with reference to FIGS. 11 to 13.

FIG. 11 illustrates the entire procedure of the processing performed by the processor 102 in the document service system 100 when the change of the content of a certain document element has been detected (when the determination result of S22 in the procedure of FIG. 4 is Yes). The processor 102 extracts a document element related to the document element (that is, changed element) having a content which has been detected to be changed, from the database in the document service system 100 (S30). In S30, all document elements having any relation to the changed element may be extracted. In this case, a document element which is not extracted is a document element having no relation to the changed element. In S30, the processor may extract a document element having a relation satisfying a specific condition with respect to the changed element. Here, for example, the specific condition includes a condition in which the type of relation corresponds to some predetermined types. In a specific example, a case where the processor extracts a document element having a relation of “citation” to the changed element is such an example. In this specific example, a document element having a relation of “similar” or “reference” to the changed element is not extracted. As another example of the specific condition, a condition in which the similarity of the content to the changed element is equal to or greater than a predetermined value may be considered. The document element specified in S30 in this manner is the notification target element.

Then, the processor 102 performs change notification processing (S32) for each extracted notification target element.

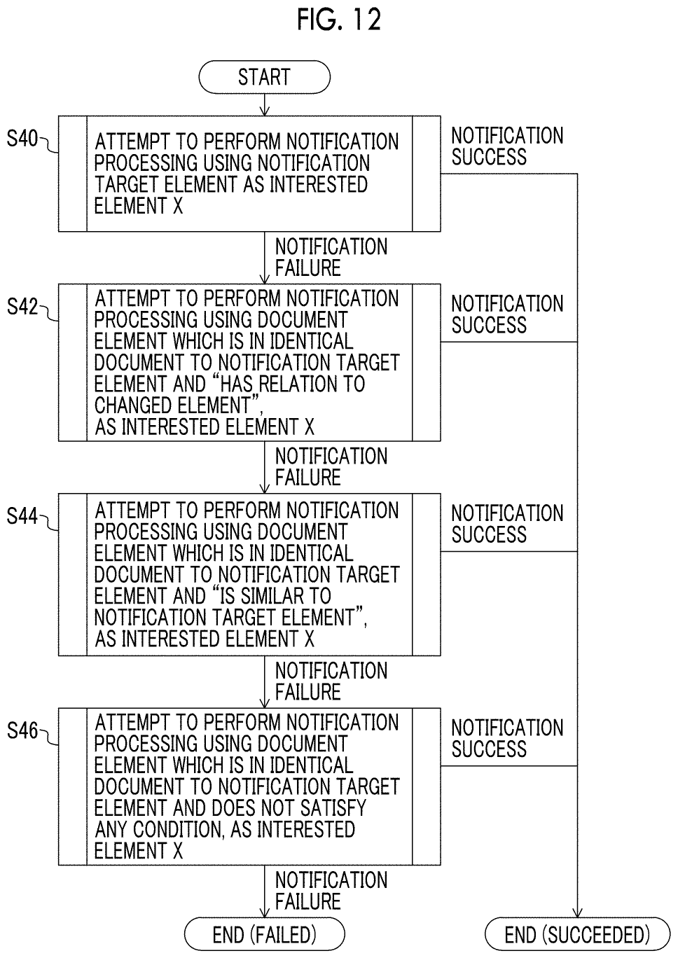

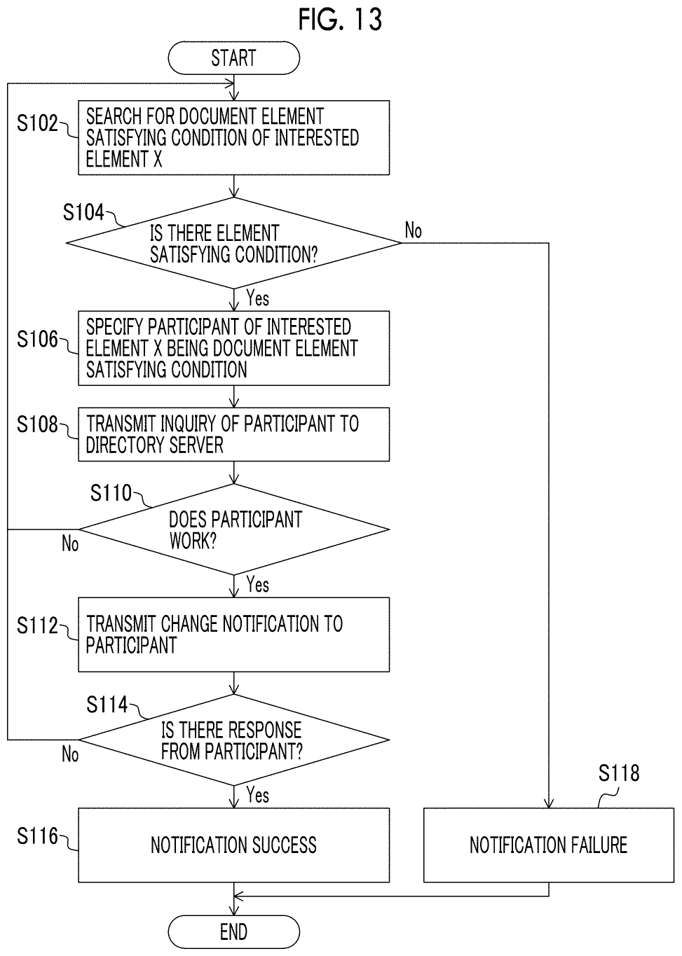

FIG. 12 illustrates a procedure of the change notification processing. In the procedure of FIG. 12, the processor 102 performs notification processing using the notification target element as an interested element X (S40). A specific example of the notification processing will be described later with reference to FIG. 13.

The processing result of S40 is either notification success or notification failure. In a case where the processing result is the notification success, the processor 102 records that the change notification for the notification target element is successful, and ends the change notification processing (S32).

In a case where the processing result in S40 is the notification failure, the processor 102 obtains a document element which belongs to the identical document to the notification target element and has a relation to the changed element, from the database. Here, similar to S30, the processor obtains a document element having a relation satisfying a specific condition with respect to the changed element. Then, the processor performs notification processing (see FIG. 13) using the obtained document element as the interested element X (S42). In a case where the processing result in S42 is the notification success, the processor 102 ends the change notification processing of the notification target element (S32).

In a case where the processing result in S42 is the notification failure, the processor 102 obtains a document element which belongs to the identical document to the notification target element and is similar to the notification target element, from the database. Here, for example, the processor obtains a document element of which the similarity to the notification target element is equal to or greater than a predetermined threshold value, from the database.

Alternatively, the processor obtains a document element having a relation of a type “similarity” to the notification target element, from the database. Then, the processor performs notification processing (see FIG. 13) using the obtained document element as the interested element X (S44). In a case where the processing result in S44 is the notification success, the processor 102 records that the change notification for the notification target element is successful, and ends the change notification processing (S32).

In a case where the processing result in S44 is the notification failure, the processor 102 obtains a document element which has not been set to the interested element X in any of S42 and S44 among document elements belonging to a document which is identical to the notification target element, from the database. Then, the processor performs notification processing (see FIG. 13) using the obtained document element as the interested element X (S46). In a case where the processing result in S46 is the notification success, the processor 102 records that the change notification for the notification target element is successful, and ends the change notification processing (S32). In a case where the processing result in S46 is the notification failure, the processor 102 records that the change notification for the notification target element has failed, and ends the change notification processing (S32).

Next, a procedure of the notification processing of each interested element X, which is performed in S40 to S46, will be described with reference to FIG. 13.

In this procedure, the processor 102 searches the database for a document element satisfying the condition of the interested element X in the currently-performed step among S40 to S46 (S102), and determines whether or not such a document element has been found (S104). In a case where the document element satisfying the condition, that is, the interested element X has been found (result in S104 is Yes), the processor 102 obtains a participant of the interested element X from the database (S106). Here, the processor obtains the last updater of the element property (see FIG. 7) of the interested element X in the database or the participant of the interested element X in the database having a data structure illustrated in FIG. 9.

Then, the processor 102 transmits an inquiry of whether or not the participant specified in S106 is registered, to the directory server 45 (S108). In the inquiry, the user ID of the specified participant is transmitted to the directory server 45. In response to the inquiry, the directory server 45 transmits a response indicating whether or not the user ID is registered in directory server 45. The processor 102 determines whether or not the participant still works for the company, based on the response (S110). In a case where the determination result is No, the processor 102 causes the process to return to S102 and searches for the next interested element X.

In a case where the determination result in S110 is Yes, the processor 102 transmits a change notification indicating that the changed element has been changed, to the participant specified in S106 (S112).

In a case where the participant who receives the change notification performs a countermeasure such as a check of whether or not the notification target element is required to be changed, or a change of the content of the notification target element in response to the change notification, the processor 102 in the document service system 100 detects that the participant performs the above countermeasure.

The processor 102 waits for the participant to perform the countermeasure for the change notification for a period having a predetermined length after transmitting the change notification in S112 to the participant (S114). Ina case where the participant performs the countermeasure for the change notification in the period, the processor 102 determines that the notification of the notification target element is successful (S116), and ends the processing in FIG. 13.

In a case where the period of the predetermined length passes in a state where the participant does not perform the countermeasure for the change notification within the period, the determination result in S114 is No. In this case, the processor 102 causes the process to return to S102 and repeats the processing in FIG. 13. In a case where the processing procedure in FIG. 13 is repeated, and no more document element satisfying the condition of the interested element X is found from the database, the determination result in S104 is No. Also in this case, the processor 102 determines that the notification of the notification target element has failed (S118), and ends the processing in FIG. 13.

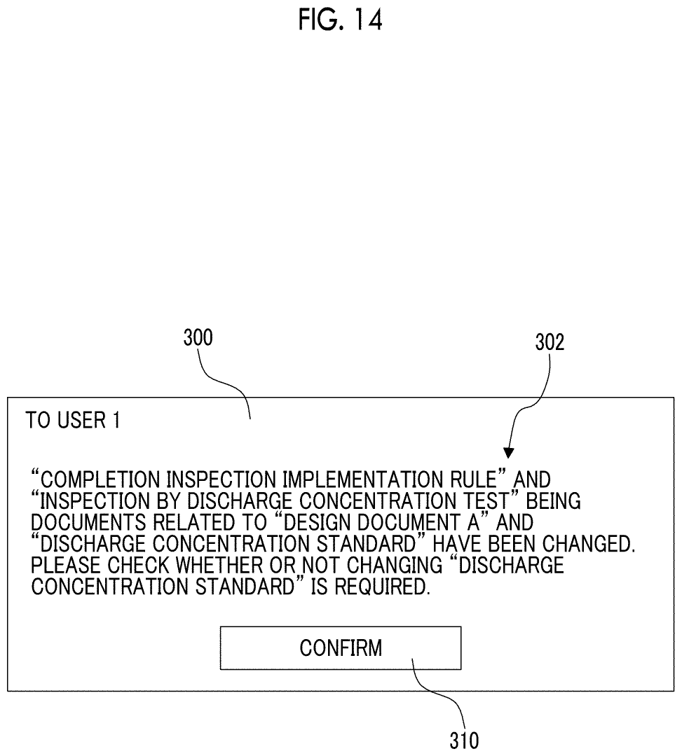

FIG. 14 illustrates an example of the change notification transmitted to the participant in S112. FIG. 14 illustrates an example of a change notification screen 300 which is displayed, in a pop-up manner, on a screen of the client 30 operated by the participant. On the change notification screen 300, a message 302 including information of specifying a changed element having the changed content and information of specifying a notification target element, that is, a document element for which a check of whether or not the content is required to be changed in response to the above change is requested is displayed. As described above, the change notification requests a check of whether or not the notification target element is required to be changed in response to the change of the changed element. In the message 302 in the example illustrated in FIG. 14, a document element of “discharge concentration standard” in a document of “design document A” is set to the notification target element, and a document element of “inspection by a discharge concentration test” in a document of “Completion inspection implementation rule B” is set to the changed element. The message 302 has a content of requesting the check of whether or not changing the notification target element is required in response to the change of the changed element, from the participant (“User 1” in this example). A confirmation button 310 is displayed on the change notification screen 300. In a case where the participant who views the change notification screen 300 presses the confirmation button 310 by a mouse click operation or the like, the processor 102 provides a terminal of the participant with a screen, for example, on which the latest content (that is, changed content) of a document element of “inspection by a discharge concentration test” in the changed document of “Completion inspection implementation rule B” and the content of a document element of “discharge concentration standard” in “design document A” using the above document as a reference are displayed. The participant determines whether or not changing the content of the notification target element “discharge concentration standard” is required, while checking the content of the changed element “inspection by a discharge concentration test”. The content before the change may be displayed together on the screen in addition to the content of the changed element after the change. In addition, information on a difference between the contents before and after the change may be displayed on the screen.

As another example of a method of providing the participant with the change notification, for example, a method of displaying the change notification in a notification field on a portal page displayed in a case where the participant logs in to the document service system 100, or a method of transmitting the change notification to an e-mail address of the participant by e-mail is provided. The e-mail address of the participant may be obtained from the directory server 45.

Example in which Participant of Document Element in Another Document is Also Set to Candidate for Transmission Destination

In the examples illustrated in FIGS. 10 and 12, the destination of transmitting the change notification is selected from participants of document elements in the identical document to the notification target element. However, this is just an example.

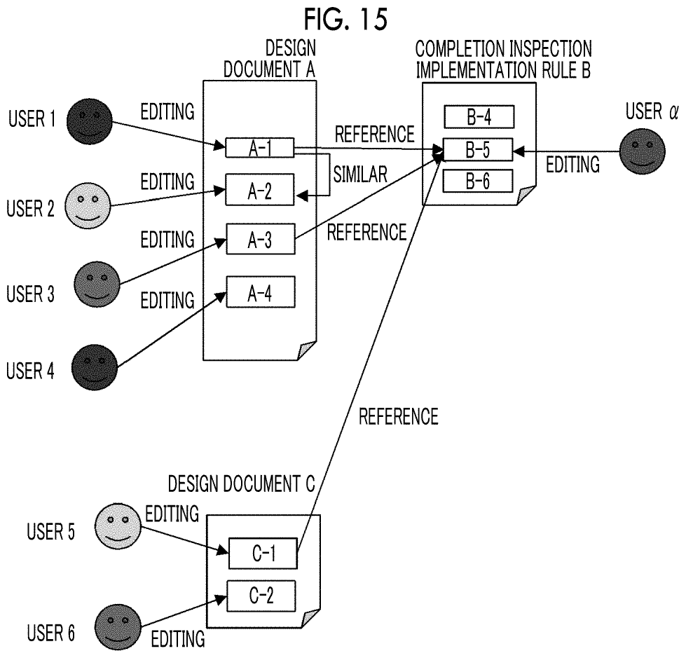

As another example, in the example illustrated in FIG. 15, a “design document C” is illustrated in addition to the “design document A” and “Completion inspection implementation rule B” illustrated in FIG. 10. The “design document C” includes document elements C-1 and C-2. User 5 and User 6 are registered, as participants of the document elements C-1 and C-2, in the “design document C”. The document element C-1 is set to use the document element B-5 as a reference, similar to the document elements A-1 and A-3. In this example, for example, in a case where the response of the participant of any document element in the identical document being the “design document A” to the document element A-1 as the notification target element, to the change notification is not possible, the change notification is transmitted to User 5 being the participant of the document element C-1 in the “design document C” which is another document using the document element B-5 as the changed element, as the reference.

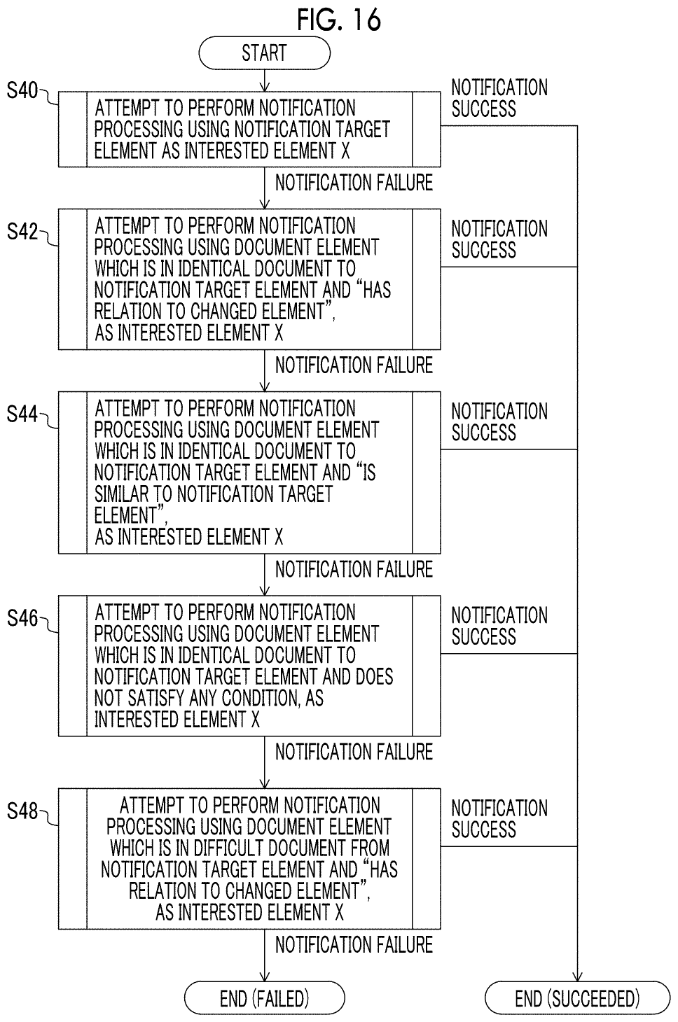

The overall processing procedure of the processor 102 in this example is identical to the processing procedure illustrated in FIG. 11. The procedure of the change notification processing (S32) is identical to the procedure illustrated in FIG. 16, not in FIG. 12. In the procedure of FIG. 16, steps similar to the steps illustrated in FIG. 12 are denoted by the identical reference signs.

In the procedure of FIG. 16, the processor 102 performs S40 to S46 as in FIG. 12. In a case where the result in S46 is “notification failed”, the processor searches for a document element related to the changed element among document elements belonging to a document different from the document to which the notification target element belongs. Here, similar to S30, the processor obtains a document element having a relation satisfying a specific condition with respect to the changed element. In a case where such a document element is searched, the searched document element is set to the interested element X, and the notification processing illustrated in FIG. 13 is performed (S48). In a case where the processing result in S48 is the notification success, the processor 102 records that the change notification for the notification target element is successful, and ends the change notification processing (S32).

The execution order of S46 and S48 may be reversed. Which case of a case where the document element is in the identical document as in S46 and a case where the document element has a relation to the changed element as in S48 is prioritized (that is, which of S46 and S48 is performed first) depends on the policy of the user.

As described with reference to FIGS. 15 and 16, the participant of the document element included in a different document from the notification target element is set to the candidates for the transmission destination of the change notification, and thus a possibility that the change notification is transmitted to the user increases.

Temporary Grant of Edit Authority to User as Notification Destination

As described above, in a case where a change notification is transmitted to a participant of a document element other than the notification target element, a person who has received the change notification may not have an edit authority for the notification target element. Even though the person who has received the change notification checks the contents of the changed element and the notification target element related to the notification, and determines that the notification target element is required to be changed as a result, in a case where the person does not have the edit authority for the notification target element, the required change is not possible. Thus, in the example described below, in a case where the participant as the transmission destination of the change notification does not have the edit authority for the notification target element, the processor temporarily grants the edit authority to the participant.

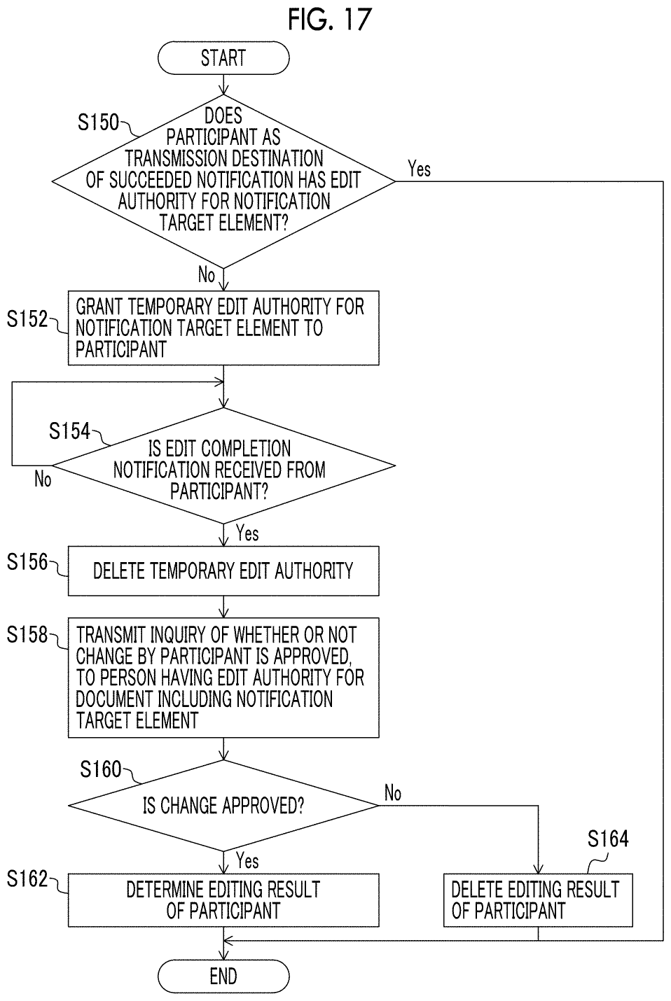

FIG. 17 illustrates a processing procedure of the above example. The procedure is performed in a case where the processing result of the notification success is obtained in S40 to S48 in FIG. 12 or 16. In this procedure, the processor 102 determines whether or not the participant as the transmission destination when the attempt of the notification has succeeded has an edit authority for the notification target element (S150). In the determination, for example, an inquiry of whether the user ID of the participant has an edit authority for the notification target element may be transmitted to the document management system (for example, design document management system 10 in the example in FIG. 1) that manages the document including the notification target element. In a case where the determination result in S150 is Yes, that is, in a case where the participant has an edit authority for the notification target element, the processor 102 ends the procedure in FIG. 17.

In a case where the determination result in S150 is No, the processor 102 temporarily grants the edit authority for the notification target element to the participant (S152). The temporary granting is implemented, for example, in a manner that the document service system 100 receives an edit of the notification target element from the participant, and the result of the edit is applied to the original of the notification target element in the document management system, with the authority of the document service system 100. As another example, the document service system 100 may request the document management system that manages the original of the notification target element, to grant the temporary edit authority for the notification target element to the participant, and the document management system may perform such authority setting in response.

Then, the processor 102 waits for receiving a notification indicating that an operation of checking, editing, and the like the notification target element is completed, from the participant (S154). In a case where the processor receives the notification, the processor deletes the granted temporary edit authority (S156).

Then, the processor 102 transmits an inquiry of whether or not the result of editing the notification target element by the participant is approved, to a person (for example, holder of the document) having an edit authority for the document including the notification target element (S158). The information on the person having the edit authority for the document including the notification target element may be acquired in a manner that the processor 102 transmits an inquiry to the document management system that manages the document. In addition, the inquiry to the person having the edit authority for the document includes, for example, the contents of the notification target element before and after the editing by the participant, and a URL for a web page indicating the changed content or the like of the changed element. The person who has received the inquiry accesses the web page using the URL, determines whether the edited content of the notification target element by the participant is appropriate, and approves or rejects the editing based on the determination.

As a result of the inquiry in S158, the processor 102 determines whether or not the edited content of the notification target element has been approved (S160). In a case where the edited content has been approved, the edited content is determined (S162). In this case, for example, the processor 102 instructs the document management system to apply and store the result of editing the notification target element by the participant into the document of the notification target element. In a case where the determination result in S160 is No, the processor 102 cancels the editing result by the participant (S164). For example, the processor instructs the document management system to discard the result of editing the notification target element by the participant and to bring the document of the notification target element back to a state before the editing.

Although not illustrated, in a case where a predetermined period passes in a state where the participant who has the temporary edit authority for the notification target element does not perform an operation of editing and the like, the processor 102 deletes the temporary edit authority.

In addition, in the procedure of FIG. 17, for the editing result of the participant who has the temporary edit authority for the notification target element, a person having the edit authority for the document including the element is asked for approval. As another example, the change notification may be transmitted to a person other than the participant of the notification target element, and an approval for the editing result performed by the person in response to the change notification may be requested from the person having the edit authority for the document including the notification target element. Others

In the above-described exemplary embodiment, for example, a plurality of document elements satisfy the condition for the interested element X in the steps of S42 to S48 in FIG. 12 or FIG. 16. In this case, for an order of selecting a document element satisfying the identical condition as the interested element X and processing the selected document element, some methods are provided.

One example is a method of selecting the document element in order of a short physical distance between the document element satisfying the condition and the notification target element in the document. This method can be used in a case where the document element in the identical document to the notification target element is selected as the interested element. In the method, the document service system 100 recognizes the position of each document element in the document. The position of a document element in a document is represented, for example, by a combination of information indicating the page of the document in which the document element is located, and the position of the document element in the page. Examples of the position of the document element in the page include the line number of the first line of the document element, or a combination of the line numbers of the first line and the last line. In another example, the position of the document element in the page is represented by a representative point (for example, the center of gravity of an area or the upper left vertex of the area) in the area of the document element in the page. In this method, the document element satisfying the condition is selected as the interested element X in order of a “close” position to the notification target element, and an attempt to transmit the change notification to the participant is made. In a case where the participant of the selected interested element X responds to the change notification, the result of the attempt to transmit the change notification is “notification success”, and the processing in FIG. 12 or 16 ends.

In another method, the document element satisfying the condition is selected as the interested element X in order of the high similarity of the content to the notification target element. A participant of a document element having high similarity is expected to have high knowledge for the notification target element.

A score obtained by applying both the physical distance from the notification target element and the similarity of the content to the notification target element may be obtained, and a document element may be selected as the interested element X in order from the highest score value.

In the exemplary embodiment described above, the document element is an element that configures a document. Here, there may be a document in a larger unit having individual documents managed by the document management system as constituent elements. In this case, the former individual document is a document element for the latter large unit document. For example, in a case where a hypertext configured with a plurality of documents linked by hyperlinks is regarded as a document of a large unit, the plurality of documents correspond to document elements in a case of being viewed from the hypertext.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to, in a case where a first document element is changed, and a response of a participant of a second document element related to the first document element to a notification of requiring a check of necessity for changing the second document element to correspond to the first document element is not possible, transmit the notification to a participant of a third document element related to the first document element or the second document element.

2. The information processing apparatus according to claim 1,
wherein the third document element is included in a second document different from a first document including the first document element.

3. The information processing apparatus according to claim 2,
wherein the second document includes the second document element.

4. The information processing apparatus according to claim 1,
wherein the processor is configured to preferentially select a document element having a higher similarity in content, as the third document element, among document elements related to the second document element.

5. The information processing apparatus according to claim 2,
wherein the processor is configured to preferentially select a document element having a highly-similar content, as the third document element, among document elements related to the second document element.

6. The information processing apparatus according to claim 3,
wherein the processor is configured to preferentially select a document element having a highly-similar content, as the third document element, among document elements related to the second document element.

7. The information processing apparatus according to claim 1,
wherein the processor is configured to select a document element in a document including the second document element, as the third document element, in preference to a document element in another document.

8. The information processing apparatus according to claim 2,
wherein the processor is configured to select a document element in a document including the second document element, as the third document element, in preference to a document element in another document.

9. The information processing apparatus according to claim 3,
wherein the processor is configured to select a document element in a document including the second document element, as the third document element, in preference to a document element in another document.

10. The information processing apparatus according to claim 4,
wherein the processor is configured to select a document element in a document including the second document element, as the third document element, in preference to a document element in another document.

11. The information processing apparatus according to claim 5,
wherein the processor is configured to select a document element in a document including the second document element, as the third document element, in preference to a document element in another document.

12. The information processing apparatus according to claim 6,
wherein the processor is configured to select a document element in a document including the second document element, as the third document element, in preference to a document element in another document.

13. The information processing apparatus according to claim 1,
wherein, in a case where the participant of the third document element does not have an edit authority for the second document element, the processor is configured to temporarily grant the edit authority for the second document element to the participant.

14. The information processing apparatus according to claim 2,
wherein, in a case where the participant of the third document element does not have an edit authority for the second document element, the processor is configured to temporarily grant the edit authority for the second document element to the participant.

15. The information processing apparatus according to claim 3,
wherein, in a case where the participant of the third document element does not have an edit authority for the second document element, the processor is configured to temporarily grant the edit authority for the second document element to the participant.

16. The information processing apparatus according to claim 4,
wherein, in a case where the participant of the third document element does not have an edit authority for the second document element, the processor is configured to temporarily grant the edit authority for the second document element to the participant.

17. The information processing apparatus according to claim 5,
wherein, in a case where the participant of the third document element does not have an edit authority for the second document element, the processor is configured to temporarily grant the edit authority for the second document element to the participant.

18. The information processing apparatus according to claim 13,
wherein, in a case where the participant of the third document element, to whom the edit authority is temporarily granted, changes the second document element in response to the notification, the processor is configured to transmit an inquiry of whether or not the participant recognizes the change, to a user having the edit authority for a document including the second document element.

19. The information processing apparatus according to claim 1,
wherein, in a case where the participant of the third document element changes the second document element in response to the notification, the processor is configured to transmit an inquiry of whether or not the participant recognizes the change, to a user having the edit authority for a document including the second document element.

20. A non-transitory computer readable medium storing a program causing a computer to perform
in a case where a first document element is changed, and a response of a participant of a second document element related to the first document element responds to a notification of requiring a check of necessity for changing the second document element to correspond to the first document element is not possible, transmitting the notification to a participant of a third document element related to the first document element or the second document element.
